(19) United States
(12) Patent Application Publication
(10) Pub. No.: US 2015/0356611 A1
(43) Pub. Date: Dec. 10, 2015

(54) PURCHASING ACTIVITY PROMOTION DEVICE AND PROGRAM

(71) Applicant: ORIGAMI INC., Minato-ku, Tokyo (JP)

(72) Inventors: Takashi NOZAWA, Tokyo (JP); Yoshiki YASUI, Tokyo (JP); Maximilian MACKEE, Tokyo (JP)

(73) Assignee: Origami Inc., Minato-Ku, Tokyo (JP)

(21) Appl. No.: 14/763,388

(22) PCT Filed: Nov. 29, 2013
(86) PCT No.: PCT/JP2013/082144

§ 371 Date: Jul. 24, 2015

(30) Foreign Application Priority Data
Jan. 24, 2013 (JP) 2013-0011404

(51) Int. Cl. G06Q 30/02

(52) U.S. Cl. CPC G06Q 30/0261

(57) ABSTRACT

The purpose of the present invention is to provide greater motivation for promoting the purchasing activity of a user. Provided is a purchasing activity promotion device comprising the following: a posted information transmission request receiving unit that receives, from a terminal device, a posted information transmission request that includes a user ID identifying a user; a posted information acquisition unit that acquires posted information that is associated with location information and relates to products or a services posted by another user having a specific relationship with the user of such user ID; and a posted information provision data transmission control unit that generates and transmits to the terminal device posted information provision data, which includes the posted information acquired by the posted information acquisition unit and the user ID of the user who posted such posted information.

### TECHNICAL FIELD

The present invention relates to a purchasing activity promotion device and program capable of promoting the activity of purchasing by a user.

### BACKGROUND ART

A type of SNS (Social Networking Service) technology which promotes the purchasing activity of a user, by introducing shops that have been visited or products that has been purchased by a person connected with such user (for example, a “friend” on such SNS etc.).

Pursuant to such technology products (and/or other similar content) that have been purchased by another person connected to such user are introduced to such user; as a result, products (and/or other similar content) introduced to such user match such user's interests.

Such a technology is disclosed in, for example, Patent Document 1.

Patent Document 1: Japanese Unexamined Patent Application, Publication No. 2008-243008

### DISCLOSURE OF THE INVENTION

### Problems to be Solved by the Invention

While the conventional technology for promoting the purchasing activity of a user introduces products or shops by way of SNS, the products or shops introduced in such way may not fit the interests of such user. For example, if information on a shop in a holiday resort is introduced by way of SNS and is browsed on a commuter train, the likelihood of the introduced information increasing the purchasing activity of such user is low.

In this way, it has been difficult for the conventional technology to accurately increase the motivation of users to promotes their purchasing activity.

The present invention has been made in view of such circumstances, and is aimed at greatly increasing the motivation of users to promote their purchasing activity.

### Means for Solving the Problems

In order to achieve the above objective, one mode of the present invention involves an information transmission receiving unit that receives information transmitted by a user (including the user ID identifying such user) (“Transmitting User”) from a portable terminal device. Based on the user ID transmitted, the transmission receiving unit extracts information posted about the product, service which has been posted by users connected to the Transmitting User and other information which was previously transmitted in connection with the location of the Transmitting User. An information transmission unit then generates and transmits data relevant to the Transmitting User including any previous transmissions to or from the mobile device of the Transmitting User.

### Effects of the Invention

The present invention encourages the purchasing activity of a user.

### BRIEF DESCRIPTION OF THE DRAWINGS

FIG. 1 is a diagram showing an overall configuration of a purchasing activity promotion system according to a first embodiment of the present invention;

FIG. 2 is a block diagram showing a hardware configuration of a portable terminal device according to an embodiment of the present invention;

FIG. 3 is a functional block diagram showing a functional configuration to execute the processing of posted information, and display of such posted information, in relation to the functional configuration of the portable terminal device shown in FIG. 2;

FIG. 4 is a schematic diagram showing an example of a linked map display screen;

FIG. 5 is a block diagram showing a hardware configuration of a purchasing activity promotion device according to an embodiment of the present invention;

FIG. 6 is a block diagram showing a functional configuration to process the receipt of posted information, and to process the transmission of posted information, in relation to the functional configuration of the purchasing activity promotion device shown in FIG. 5;

FIG. 7 is a diagram showing a structure of the posted information database;

FIG. 8 is a diagram showing a structure of the user relationship information database;

FIG. 9 is a flowchart illustrating the process by which posted information is processed by the portable terminal device shown in FIG. 2 and having the functional configuration of FIG. 3;

FIG. 10 is a flowchart illustrating the process by which posted information is displayed by the portable terminal device having the functional configuration of FIG. 3;

FIG. 11 is a flowchart illustrating the process by which posted information is received by the purchasing activity promotion device having the functional configuration of FIG. 6; and

FIG. 12 is a flowchart illustrating the process by which posted information is transmitted by the purchasing activity promotion device having the functional configuration of FIG. 6.

### PREFERRED MODE FOR CARRYING OUT THE INVENTION

Embodiments of the present invention are hereinafter described with reference to the drawings.

### First Embodiment

### Configuration

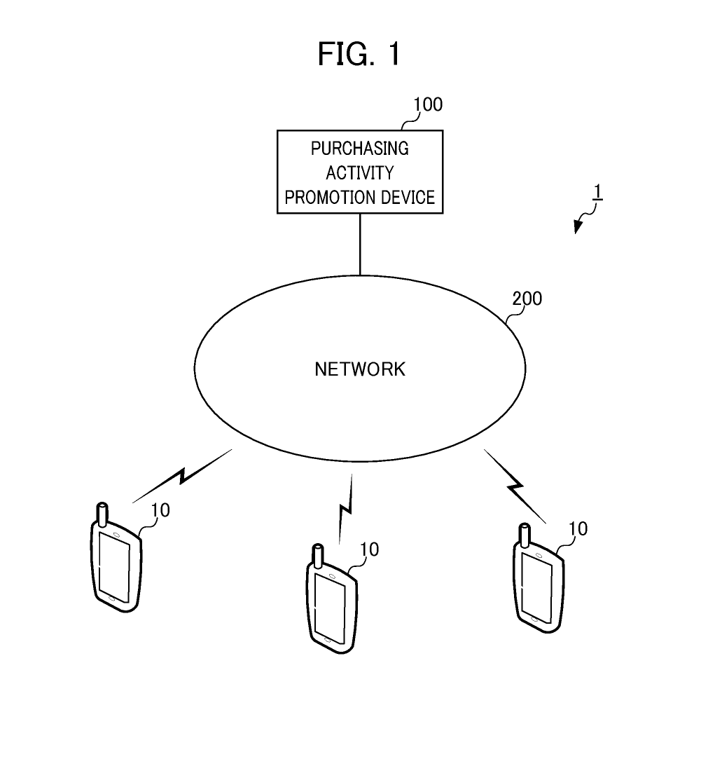

FIG. 1 is a diagram showing an overall configuration of a purchasing activity promotion system 1 according to a first embodiment of the present invention.

In FIG. 1, the purchasing activity promotion system 1 is configured to include a multiple portable terminal devices 10 and a purchasing activity promotion device 100, which are constructed to enable communication via a network 200 comprising of the Internet or similar medium.

The portable terminal device 10 of the present embodiment can be configured by a portable information processing device such as a smartphone, a PDA (Personal Digital Assistant), a mobile telephone device, a laptop PC, or the like.

The purchasing activity promotion device 100 can be configured by a server or a PC.

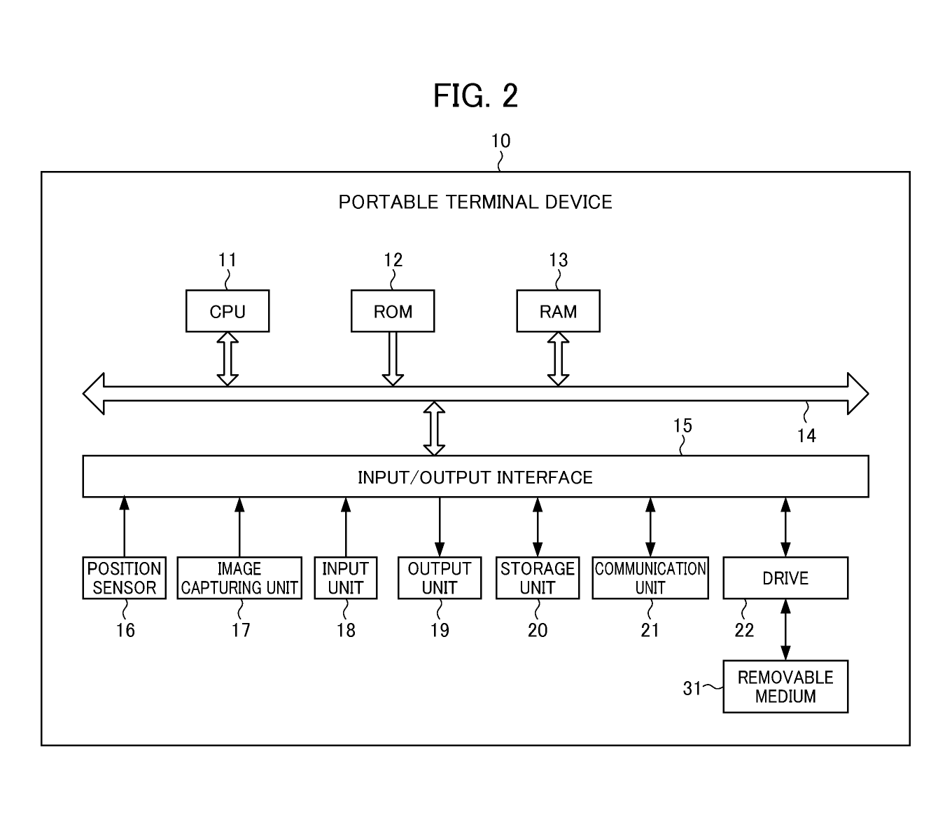

FIG. 2 is a block diagram showing a hardware configuration of the portable terminal device 10 according to an embodiment of the present invention.

The portable terminal device 10 includes a CPU (Central Processing Unit) 11, a ROM (Read Only Memory) 12, a RAM (Random Access Memory) 13, a bus 14, an input/output interface 15, a position sensor 16, an image capturing unit 17, an input unit 18, an output unit 19, a storage unit 20, a communication unit 21, and a drive 22.

The CPU 11 carries out various processing functions in accordance with a program loaded in ROM 12, or a program loaded in storage unit 20 by the RAM 13.

The RAM 13 also stores data and similar content necessary for the CPU 11 to execute any processing, as appropriate.

The CPU 11, the ROM 12 and the RAM 13 are mutually connected via the bus 14. The input/output interface 15 is also connected to the bus 14. The position sensor 16, the image capturing unit 17, the input unit 18, the output unit 19, the storage unit 20, the communication unit 21 and the drive 22 are connected to the input/output interface 15.

The position sensor 16 includes a GPS (Global Positioning System) sensor to confirm the current location of the portable terminal device 10. The position sensor 16 transmits the location information determined, which thereby indicates the current location of the portable terminal device 10, to the CPU 11. In addition to utilizing GPS, it is also possible for the position sensor 16 to acquire location information by utilizing the intensity of electromagnetic waves received from base stations of a cellular system.

The image capturing unit 17 includes an optical lens unit and an image sensor (not shown).

In order to capture an image of a subject, the optical lens unit is composed of lenses for condensing light, such as a focus lens and a zoom lens.

The focus lens forms a image of the subject on the photoreceptor plane of the image sensor. The zoom lens freely alters the focal distance within a certain range.

The optical lens unit also includes a peripheral circuit for adjusting configuration parameters such as focus, exposure and white balance, as necessary.

The image sensor is composed of photoelectric conversion elements, AFE (Analog Front End), etc.

The photoelectric conversion elements are configured by CMOS (Complementary Metal Oxide Semiconductor)-type photoelectric conversion elements, etc. A subject image enters the photoelectric conversion elements through the optical lens unit. By way of the photoelectric conversion elements, the subject image undergoes photoelectric conversion (i.e. is captured); image signals are accumulated for a certain period of time; and the accumulated image signals are sequentially supplied as analog signals to the AFE.

The AFE executes a variety of signal processing such as A/D (Analog/Digital) conversion processing on the analog image signals. The variety of signal processing generates digital signals to be output as output signals of the image capturing unit 17.

Such output signals of the image capturing unit 17 are hereinafter referred to as “data of a captured image”. The data of the captured image is supplied to the CPU 11, etc. as appropriate. In the present embodiment, the image capturing unit 17 outputs any one of static image data and moving image data, as data of a captured image.

The input unit 18 is composed of various buttons, a touchscreen overlaid on a display that composes the output unit 19, and the like, and inputs a variety of information in response to instruction operations by the user.

The output unit 19 is composed of a display, a speaker, etc., and outputs images and sound.

The storage unit 20 is composed of a hard disk, DRAM (Dynamic Random Access Memory) or the like, and stores data of various images.

The communication unit 21 controls communication with other devices via the network 200.

A removable medium 31, which is composed of a magnetic disk, an optical disk, a magneto-optical disk, semiconductor memory or the like, is mounted to the drive 22, as appropriate. Programs that are read via the drive 22 from the removable medium 31 are installed in the storage unit 20, as necessary. Similarly to the storage unit 20, the removable medium 31 can also store a variety of data such as image data stored in the storage unit 20.

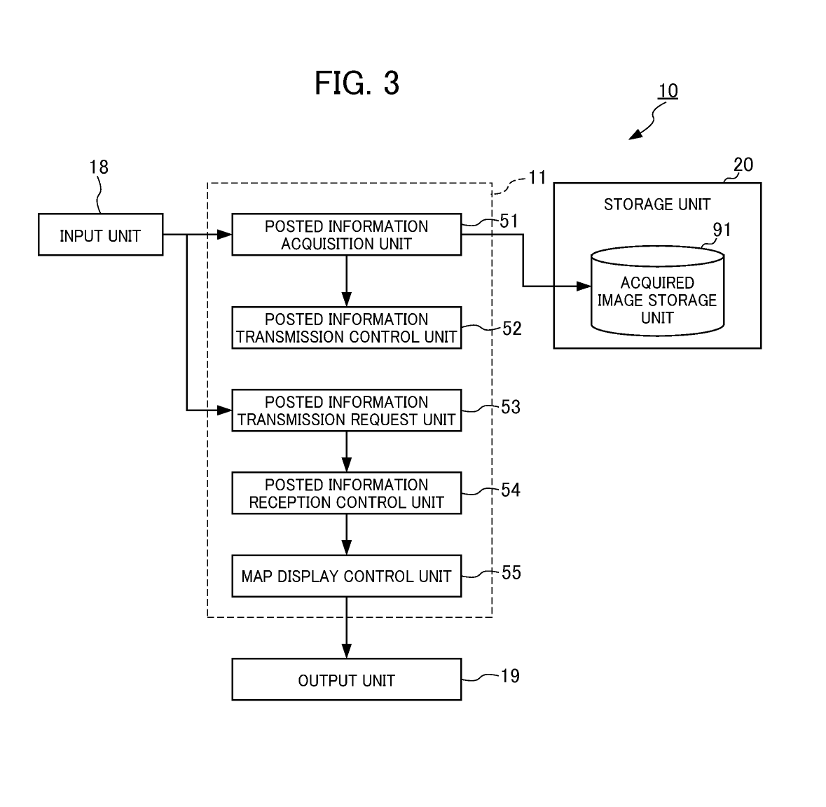

FIG. 3 is a block diagram showing a functional configuration for information posting processing, and posted information displaying processing, in relation to the functional configuration of the portable terminal device 10 shown in FIG. 2.

The sequence of information posting processing is that the user of the portable terminal device 10 posts information relating to a product or shop on the purchasing activity promotion device 100.

Where the user of the portable terminal device 10 displays a map, the sequence of posted information display processing is that display information posted by another user connected with such user is displayed in association with the map.

As shown in FIG. 3, where the information posting processing and posted information displaying processing is executed, a posted information acquisition unit 51, a posted information transmission control unit 52, a posted information transmission request unit 53, a posted information reception control unit 54, and a map display control unit 55 function in the CPU 11.

However, FIG. 3 is an illustrative example. For example, a GA (graphic accelerator) may be provided as hardware for image processing; and at least a part of the functions of the CPU 11 may be delegated to the GA.

Where the aforementioned processing is executed, an acquired image storage unit 91 is used, which is provided as an area of the storage unit 20.

The acquired image storage unit 91 stores the data of a captured image (static/moving image data) acquired by the image capturing unit 17.

The posted information acquisition unit 51 records information about products or services which are inputted by the user (hereinafter referred to as “posted information”). Specifically, with regard information inputted by the user, the posted information acquisition unit 51 records posted information such as data of the captured image stored in the acquired image storage unit 91, data of various images stored in the storage unit 20, a shop URL (uniform resource locator) which is inputted via the input unit 18; and transmits the posted information to the purchasing activity promotion device 100 via the network 200.

The posted information transmission control unit 52 adds the user ID of the user of the portable terminal device 10, and the current location of the portable terminal device 10 as determined by the position sensor 16, to the posted information received by the posted information acquisition unit 51; and transmits the incorporated information to the purchasing activity promotion device 100.

Where the user inputs an instruction to display a map, the posted information transmission request unit 53 transmits a posted information transmission request (information including a map data transmission request as well as the location information and the user ID) to the purchasing activity promotion device 100. At this time, if the information designating the location to be displayed in the map (hereinafter referred to as “location designation information”) is not inputted by the user, the posted information transmission request unit 53 transmits the user ID and the current location of the portable terminal device 10 as location information, together with the map data transmission request, to the purchasing activity promotion device 100. Where the location designation information is inputted by the user, the posted information transmission request unit 53 transmits the user ID and the location designation information as location information, together with the map data transmission request, to the purchasing activity promotion device 100.

Upon receiving linked map data (to be described later as the posted information provision data) from the purchasing activity promotion device 100, the posted information reception control unit 54 extracts: map data included in the linked map data; link information; content represented by the link (static/moving image data, etc.); and the user ID of the other user who has posted the content. The posted information reception control unit 54 then outputs the extracted information to the map display control unit 55.

Based on the map data contained in the linked map data, the link information, the content represented by the link, and the ID of the user who posted the content, which have each been inputted from the posted information reception control unit 54, a display screen which includes a map which identifiably displays the existence of link information and a list of the contents represented by the link (hereinafter referred to as a “linked map display screen”) is generated by the map display control unit 55. The map display control unit 55 outputs the data generated of the linked map display screen to the output unit 19, and causes the output unit 19 to display the map which identifiably displays the existence of link information, and the list of the contents represented by the link.

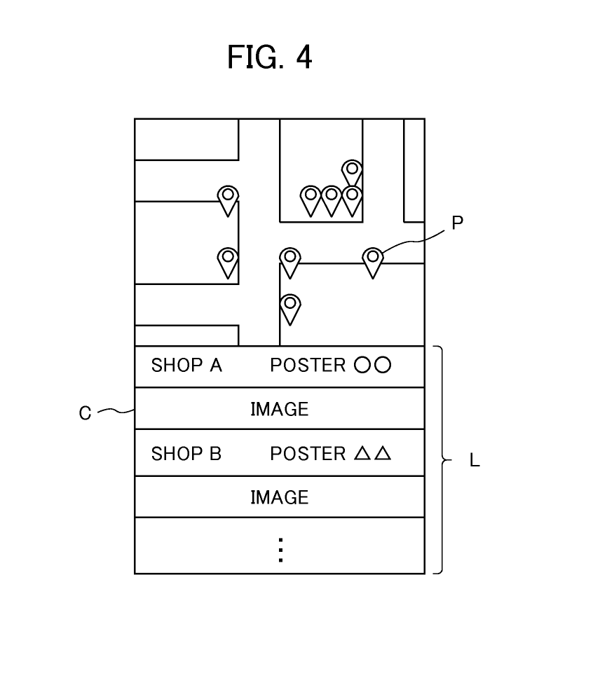

FIG. 4 is a schematic diagram showing an example of the linked map display screen.

As shown in FIG. 4, the linked map display screen includes: a map of the neighborhood of the current location of the user; a pin P (identification information) indicating the existence of a link associated with any location in the map; and a list L listing the content C (static/moving image, etc.) relating to a product or shop represented by the link of each pin.

When the user touches any of the pins P in the linked map display screen shown in FIG. 4, a content C linked to the pin P is displayed in an enlarged manner.

Therefore, according to the purchasing activity promotion system 1 of the present embodiment, when the user is taking a walk through the town, etc., the linked map display screen displays information, which has been posted by another person such as one registered as “friend” connected with the user, where such information has been posted in connection with the neighborhood of the current location of the user. Therefore, since the information displayed id about a product or shop located close to such user, such user is more likely to be interested in the information.

This increases the user's motivation to actually view the product or shop so displayed.

Namely, the purchasing activity promotion system 1 of the present embodiment makes it possible to provide greater motivation which promotes the purchasing activity of the user.

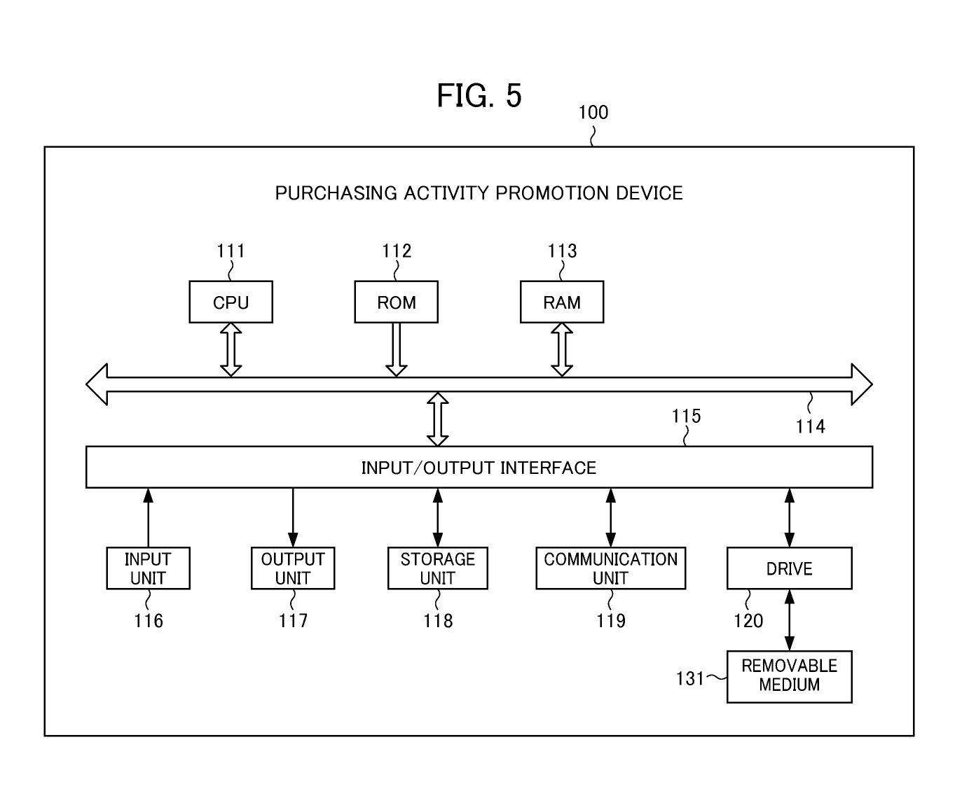

FIG. 5 is a block diagram showing a hardware configuration of the purchasing activity promotion device 100 according to an embodiment of the present invention.

The purchasing activity promotion device 100 includes a CPU (Central Processing Unit) 111, a ROM (Read Only Memory) 112, a RAM (Random Access Memory) 113, a bus 114, an input/output interface 115, an input unit 116, an output unit 117, a storage unit 118, a communication unit 119, and a drive 120.

The CPU 111 executes a variety of processing in accordance with a program recorded in the ROM 112, or a program loaded from the storage unit 118 by the RAM 113.

The RAM 113 also stores data and similar content necessary for the CPU 111 to execute the various processing functions, as appropriate.

The CPU 111, the ROM 112 and the RAM 113 are mutually connected via the bus 114. The input/output interface 115 is also connected to the bus 114. The input unit 116, the output unit 117, the storage unit 118, the communication unit 119 and the drive 120 are connected to the input/output interface 115.

The input unit 116 is composed of various buttons, a touchscreen overlaid on a display that composes the output unit 117 (and similar equipment), and inputs a variety of information in response to instructions of the user.

The output unit 117 is composed of a display, a speaker, etc., and outputs images and sound.

The storage unit 118 is composed of a hard disk, DRAM (Dynamic Random Access Memory) or the like, and stores data of various images.

The communication unit 119 controls communication with other devices via the network 200.

A removable medium 31, which is composed of a magnetic disk, an optical disk, a magneto-optical disk, semiconductor memory or the like, is mounted to the drive 120, as appropriate. Programs that are read via the drive 120 from the removable medium 131 are installed in the storage unit 118, as necessary. Similarly to the storage unit 118, the removable medium 131 can also store a variety of data such as image data stored in the storage unit 118.

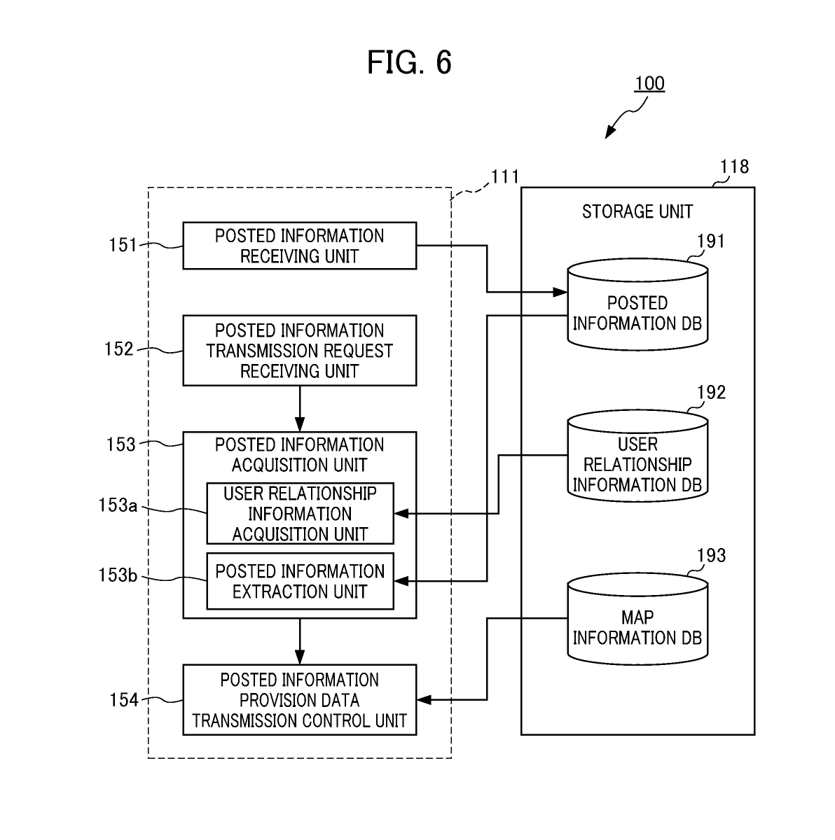

FIG. 6 is a block diagram showing a functional configuration for executing the posted information reception processing, and posted information transmission processing, in relation to the functional configuration of the purchasing activity promotion device 100 shown in FIG. 5.

The posted information reception processing is a sequence of processing to register posted information with a posted information database, when the information of a product or shop is posted by the user of the portable terminal device 10.

The posted information transmission processing is a sequence of processing to transmit the linked map data, in response to the posted information transmission request from the portable terminal device 10.

As shown in FIG. 6, where the posted information reception processing and the posted information transmission processing are executed, each of the posted information receiving unit 151, posted information transmission request receiving unit 152, posted information acquisition unit 153, and posted information provision data transmission control unit 154 shall function in the CPU 111.

Where the aforementioned processing is executed, a posted information database 191, a user relationship information database 192, and a map information database 193 are used, each of which is provided as an area within storage unit 118.

The posted information database 191 stores data of the posted information received by the posted information receiving unit 151.

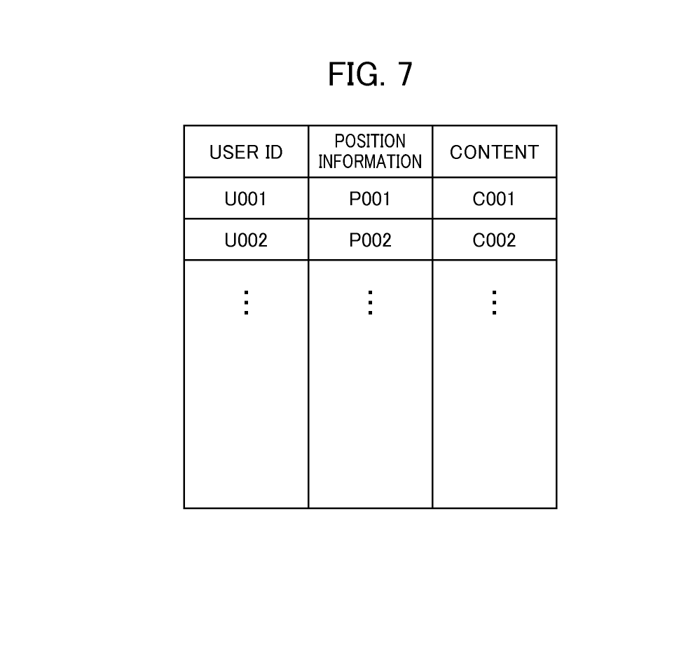

FIG. 7 is a diagram showing a data structure of the posted information database 191.

As shown in FIG. 7, the posted information database 191 stores each of the ID of the user who posted the posted information, the location information corresponding to such posted information, and the data relating to the content (static/moving image, etc.) of the posted information, together.

For example, in the first line of the posted information database 191 in relation to content “C001” of the posted information, the user ID “U001” of the user who posted the content “C001” and location information “P001” would be stored together.

Where a shop URL is posted together with the content of the posted information, the shop URL is added to the data structure of the posted information database 191 shown in FIG. 7.

The user relationship information database 192 stores the relationships among users (hereinafter referred to as “user relationship”), which are registered with the purchasing activity promotion system 1. In the present embodiment, the purchasing activity promotion system 1 has an SNS function to manage the user attributes of registered members (user ID, name, mail address, etc.) and the relationships among users (“friend”, “family”, etc.). In addition to the purchasing activity promotion system 1 having the SNS function, the purchasing activity promotion system 1 may also realize the SNS function in collaboration with another SNS.

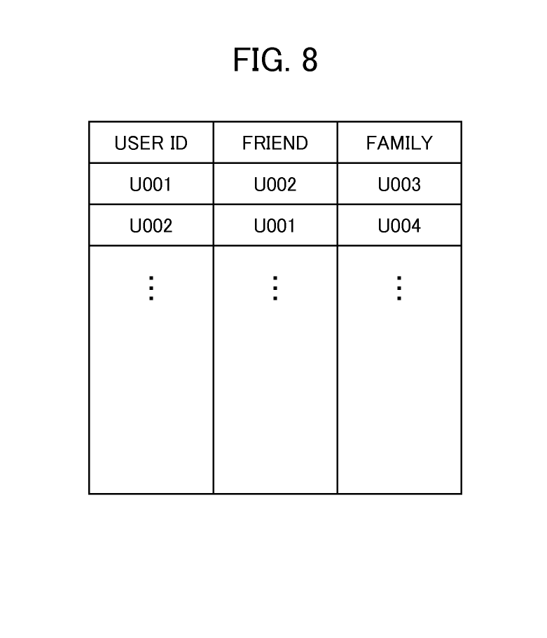

FIG. 8 is a diagram showing a data structure of the user relationship information database 192.

As shown in FIG. 8, the user and the other users which have been registered as having various relationship with the user are stored in the user relationship information database 192 in association with each other.

For example, on the first line of the user relationship information database 192, a user ID “U001” has various kinds of relationships with user IDs “U002” and “U003”” (relationships registered as “friend” or “family”, etc.) and are stored in association with each other.

The map information database 193 stores information regarding the map (map data) which has been generated in advance.

Upon receiving the posted information from the portable terminal device 10, the posted information receiving unit 151 extracts static/moving image data or a shop URL, a user ID and location information, from the posted information. The posted information receiving unit 151 stores the static/moving image data or shop URL, the user ID and location information, which are then extracted into the posted information database 191.

Upon receiving the posted information transmission request from the portable terminal device 10, the posted information transmission request receiving unit 152 extracts the user ID and the location information included in the posted information transmission request. The posted information transmission request receiving unit 152 outputs the user ID and the location information, which is transmitted to the posted information acquisition unit 153.

The posted information acquisition unit 153 includes the user relationship information acquisition unit 153a and posted information extraction unit 153b.

When the user ID and the location information are inputted from the posted information transmission request receiving unit 152, the user relationship information acquisition unit 153a refers to the user relationship information database 192, and detects any other users having a relationship with the user who has inputted the posted information.

The posted information extraction unit 153b refers to the posted information database 191, and extracts posted information associated with the location information from the neighborhood included in the map data transmission request (for example, within an area displayed as a map), from other users detected pursuant to the user relationship information acquisition unit 153a.

The posted information acquisition unit 153 outputs the posted information extracted by the posted information extraction unit 153b which is relevant to the associated user ID and location information, to the posted information provision data transmission control unit 154. The posted information acquisition unit 153 outputs the location information, which is included in the map data transmission request, to the posted information provision data transmission control unit 154.

When the location information, which is included in the map data transmission request, is inputted from the posted information acquisition unit 153, the posted information provision data transmission control unit 154 refers to the map information database 193, and acquires map data which correlates to such location information.

The posted information provision data transmission control unit 154 creates linked map data (posted information provision data) by linking information to the posted information which has been input from the posted information acquisition unit 153 to the map data; this is then transmitted as the linked map data, together with the posted information, the user ID and the location information, to the portable terminal device 10.

### Operation

The operations of the purchasing activity promotion system 1 are described below.

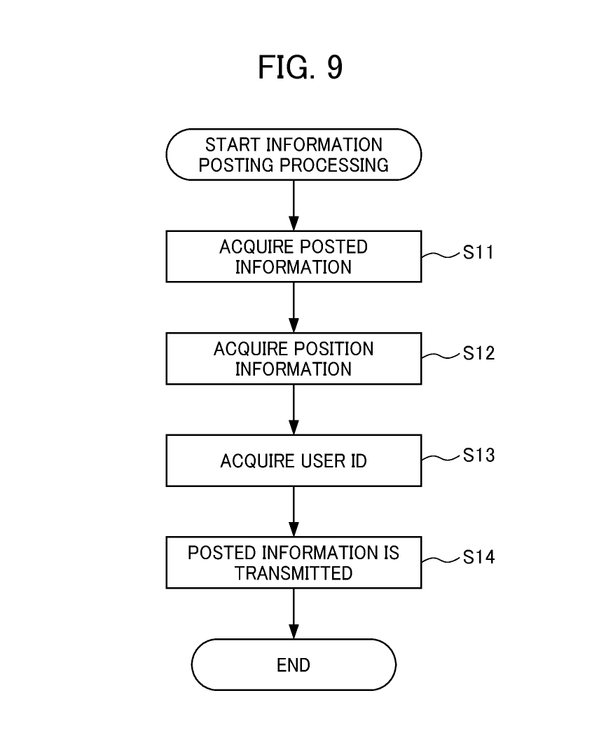

Firstly, the information posting processing is described by referring to FIG. 9, in relation to the processing executed by the portable terminal device 10 with functional configuration FIG. 3.

FIG. 9 is a flowchart illustrating the flow of the information posting processing executed by the portable terminal device 10 shown in FIG. 2 with functional configuration FIG. 3.

In the present embodiment, the information posting processing is initiated when the user inputs an instruction to execute the information posting processing.

In Step S11, the posted information acquisition unit 51 acquires the posted information which is inputted from the user. The posted information acquired at this time is: data of a captured image stored in the acquired image storage unit 91; data of various images stored in the storage unit 20; a shop URL which has been input via the input unit 18; etc.

In Step S12, the posted information transmission control unit 52 acquires location information (the current position or location designation information of the portable terminal device 10).

In Step S13, the posted information transmission control unit 52 acquires the ID of the user of the portable terminal device 10.

In Step S14, the posted information transmission control unit 52 transmits the posted information, together with the user ID and the location information, to the purchasing activity promotion device 100.

When the processing in Step S14 is terminated, the information posting processing is terminated.

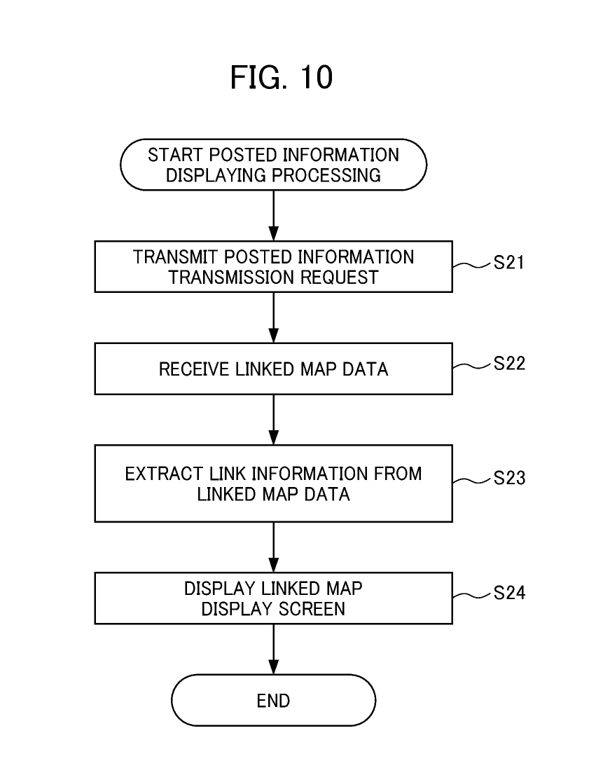

Next, by referring to FIG. 10, the posted information displaying processing is described in relation to the processing executed by the portable terminal device 10 with functional configuration FIG. 3.

FIG. 10 is a flowchart illustrating the flow of the posted information displaying processing executed by the portable terminal device 10 with functional configuration FIG. 3.

In the present embodiment, the posted information displaying processing is initiated when the user inputs an instruction to execute posted information displaying processing.

In Step S21, the posted information transmission request unit 53 transmits a posted information transmission request to the purchasing activity promotion device 100. At this time, the posted information transmission request unit 53 transmits a posted information transmission request, together with a map data transmission request, to the purchasing activity promotion device 100, where the posted information transmission request is composed of the current location of the portable terminal device 10, or the location designation information (location information) that is input by the user, and the ID of the user of the portable terminal device 10.

In Step S22, the posted information reception control unit 54 receives linked map data (posted information provision data) from the purchasing activity promotion device 100.

In Step S23, the posted information reception control unit 54 extracts map data, link information, content represented by the link, and the ID of the user who is posting, from the linked map data.

In Step S24, the map display control unit 55 displays a linked map display screen, based on the map data of the linked map data, the link information, the content represented by the link, and the ID of the user who posted the content.

When the processing in Step S24 is terminated, the posted information displaying processing is terminated.

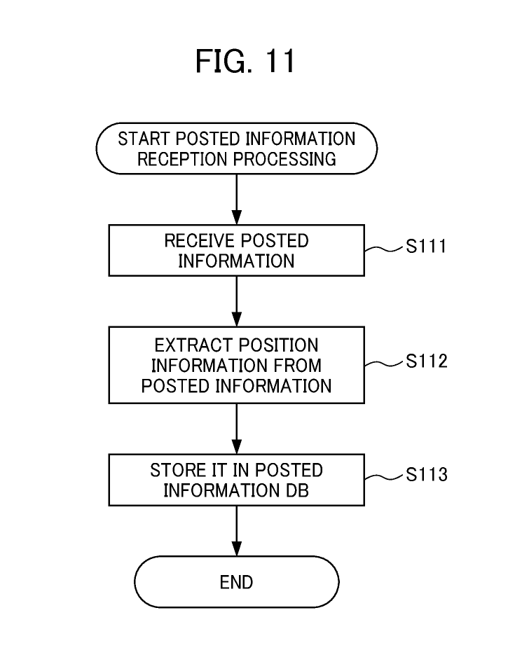

Next, by referring to FIG. 11, the posted information reception processing is described, in relation to the processing executed by the purchasing activity promotion device 100 with functional configuration of FIG. 6.

FIG. 11 is a flowchart illustrating the flow of the posted information reception processing executed by the purchasing activity promotion device 100 having the functional configuration of FIG. 6.

In the present embodiment, the posted information reception processing is executed at predetermined time intervals after the purchasing activity promotion device 100 is activated.

In Step S111, the posted information receiving unit 151 receives posted information from the portable terminal device 10.

In Step S112, the posted information receiving unit 151 extracts static/moving image data or a shop URL, a user ID and location information, from the posted information thus received.

In Step S113, the posted information receiving unit 151 stores the static/moving image data or the shop URL, the user ID and the location information, which are then extracted into the posted information database 191 (refer to FIG. 7).

When the processing in Step S113 is terminated, the posted information reception processing is terminated.

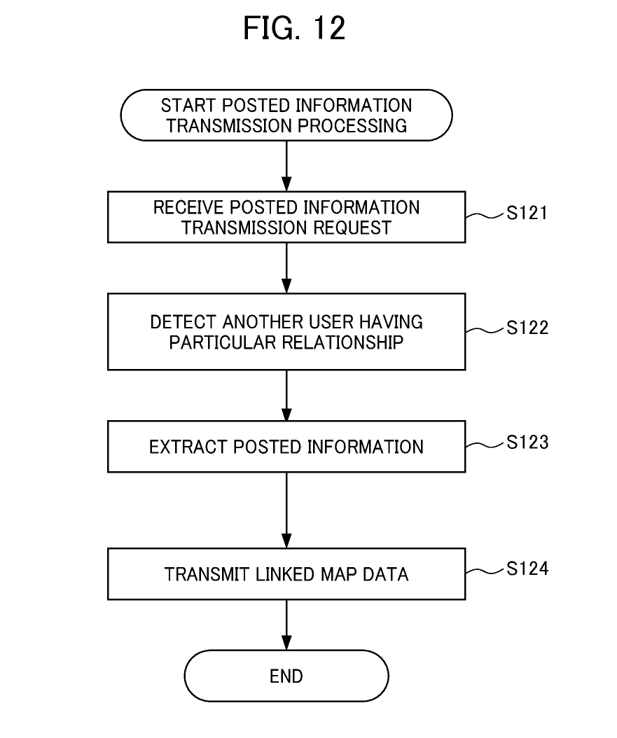

Next, by referring to FIG. 12, the posted information transmission processing is described, in relation to the processing executed by the purchasing activity promotion device 100 with functional configuration of FIG. 6.

FIG. 12 is a flowchart illustrating the flow of the posted information transmission processing executed by the purchasing activity promotion device 100 with functional configuration of FIG. 6.

In the present embodiment, the posted information transmission processing is executed at predetermined time intervals after the purchasing activity promotion device 100 is activated.

In Step S121, the posted information transmission request receiving unit 152 receives a posted information transmission request from the portable terminal device 10.

In Step S122, based on the user ID and the location information which is received by the posted information transmission request receiving unit 152, the user relationship information acquisition unit 153a of the posted information acquisition unit 153 refers to the user relationship information database 192, and detects others user having a particular relationship with the user of such user ID.

In Step S123, the posted information extraction unit 153b of the posted information acquisition unit 153 refers to the posted information database 191, and extracts posted information associated with the location information included in the posted information transmission request which has been posted by other users detected pursuant to the user relationship information acquisition unit 153a.

In Step S124, based on the location information included in the posted information transmission request, the posted information provision data transmission control unit 154 acquires map data by referring to the map information database 193, and generates linked map data to be transmitted to the portable terminal device 10.

When the processing in Step S124 is terminated, the posted information transmission processing is terminated.

As described above, in the purchasing activity promotion system 1 of the present embodiment, the plurality of portable terminal devices 10 are connected to the purchasing activity promotion device 100 via the network 200. The purchasing activity promotion device 100 includes the posted information transmission request receiving unit 152, the posted information acquisition unit 153, and the posted information provision data transmission control unit 154.

The posted information transmission request receiving unit 152 receives a posted information transmission request, which includes the user ID identifying the user and the location information representing such users location, from the portable terminal device.

Based on the user ID and the location information, the posted information acquisition unit 153 acquires posted information about products or services which have been posted by other user having a particular relationship with the user with such user ID, where the posted information is associated with the location represented by the location information.

The posted information provision data transmission control unit 154 generates posted information provision data, which includes the posted information acquired by the posted information acquisition unit 153 and the user ID of the user who posted the posted information, and transmits the posted information provision data to the portable terminal device.

Based on the posted information provision data thereby received, the portable terminal device provides the user with information by displaying the posted information of such location on the map, or by making a sound/vibration notification.

In this case, the posted information has been provided by another user having a particular relationship with the user.

The information is displayed about products or shops located in the vicinity of such user.

Therefore, the user is more likely to be interested in the posted information displayed, and it is possible to provide greater motivation to promote the purchasing activity of the user.

The posted information transmission request receiving unit 152 receives a map display request, which includes the ID identifying such user and the location information representing the location of the map to be displayed. The posted information provision data transmission control unit generates linked map data, in which the posted information acquired by the posted information acquisition unit and the ID of the user who posted the posted information are linked to the map data acquired pursuant to the location information, and transmits such data to the portable terminal device.

Therefore, the posted information can be displayed to the user as a link on the map.

Therefore, it is possible to provide greater motivation that promotes the purchasing activity of the user.

The linked map includes: the identification information indicating the existence of posted information displayed on the map; and the list of posted information corresponding to the identification information. When the identification information on the map is selected, the posted information corresponding to the selected identification information is identified and displayed in the list of posted information.

Therefore, the posted information can be displayed in a way that is easy to identify for the user.

The present invention is not limited to the above-mentioned embodiments, but includes variations, improvements, etc. within the scope that can be achieve pursuant to the object of the present invention.

### Modification Example 1

The embodiments have been described above such that the ID of the user of the portable terminal device 10 is transmitted as included in the posted information transmission request; however, the ID of another user (girlfriend, wife, friend, etc.) may be designated and included in the posted information transmission request, instead of the ID of the user of the portable terminal device.

Therefore, the map display request may include the ID of a user designated by the user of the portable terminal device; and based on the ID of the designated user and the location information, the posted information acquisition unit may acquire posted information about products or services which have been posted by another user having a particular relationship with the designated user, where the posted information is associated with a registered area from the position represented by the location information.

In this case, it is possible to present posted information that is likely to be of interest to another user designated by such user; therefore, it is possible to present posted information that is useful where such user purchases a present for another user.

### Modification Example 2

Further, in the aforementioned embodiments, a user who visits a real shop or neighborhood of a real shop can be given guidance to an online store associated with the shop.

Specifically, the portable terminal device 10, which is owned by the shop providing a product or service, transmits a URL of the online store associated with the shop, in association with a static/moving image, etc. of the shop, to the purchasing activity promotion device 100; and the purchasing activity promotion device 100 stores the URL in association with the location information of the shop.

Based on the location information received by the location information receiving unit, if the purchasing activity promotion device 100 detects that the portable terminal device 10 of a user having a particular relationship with the shop is positioned in the neighborhood of the shop (for example, within a 30 meter radius) or within the shop, a URL transmitting unit transmits the URL of the online store associated with the shop to the portable terminal device 10.

As a result, the user who visits the real shop or the neighborhood thereof can be guided to the online store associated with the shop; therefore, potential for purchasing activity can be improved to users other than users who are actually purchasing products or the like within such real shop. This also enables the user, for example, to receive a product or similar content at home, after taking a look at it at the real shop.

### Modification Example 3

Further, in the aforementioned embodiments, a user who visits a real shop or the neighborhood thereof can also be guided to a website associated with the shop (for example, an official website operated by the shop brand, etc.).

Specifically, the portable terminal device 10, which is owned by the shop providing a product or service, transmits a URL of the website associated with the shop, in association with a static/moving image, etc. of the shop, to the purchasing activity promotion device 100; and the purchasing activity promotion device 100 stores the URL in association with the location information of the shop.

Based on the location information received by the location information receiving unit, if the purchasing activity promotion device 100 detects that the portable terminal device 10 of a user having a particular relationship with the shop is positioned in the vicinity of the shop (for example, within a 30 meter radius) or within the shop, a URL transmitting unit transmits the URL of the website associated with the shop to the portable terminal device 10. At this time, the URL transmitting unit of the purchasing activity promotion device 100 transmits the marketing information such as discount information and/or campaign information (hereinafter referred to as “marketing information”), together with the URL of the website.

This makes it possible to improve the buying motivation of the user who has received the marketing information. The user who visits the real shop or the neighborhood thereof can be guided to the website associated with the shop; therefore, the potential for purchasing activity can be improved for users beyond the user who purchases a product or the like at the real shop.

### Modification Example 4

Further, in the aforementioned embodiments, credit-card settlement services can be made available at shops which have not subscribed as credit card merchants.

Specifically, where a user having a particular relationship with a shop providing a product or service visits the shop to purchase a product or the like, a purchase information receiving unit of the purchasing activity promotion device 100 receives information indicating that the user will purchase the product or the like. A page data transmitting unit of the purchasing activity promotion device 100 transmits data of an input page for the credit-card settlement to the portable terminal device 10 of the user who purchases the product or the like.

The user who purchases the product or the like fills out the input page with necessary information, and sends a reply to the purchasing activity promotion device 100; and the page data receiving unit of the purchasing activity promotion device 100 receives the reply. A payment execution unit of the purchasing activity promotion device 100 makes a settlement with the credit card company, thereby completing the payment.

This enables the user to use a credit card to purchase and take out a product or the like which is sold at a real shop. Even if a shop, from which a product or the like is sold, is not subscribed as a credit card merchant, the shop can make credit-card settlements intermediated by the purchasing activity promotion device 100; therefore, it is possible to avoid losing the opportunity to sell goods due to the unavailability of credit cards.

In the present modification example, instead of the data of the input page for the credit-card settlement, for example, data of an input page for another payment option such as bank transfer or cash on delivery may be transmitted from the page data transmitting unit of the purchasing activity promotion device 100 to the portable terminal device 10.

In this case as well, the user who purchases the product or the like fills out the input page with necessary information, and sends a reply to the purchasing activity promotion device 100; and the page data receiving unit of the purchasing activity promotion device 100 receives the reply. The payment execution unit of the purchasing activity promotion device 100 executes the payment processing such as execution of bank transfer or arrangement of cash on delivery, thereby completing the payment.

### Modification Example 5

The embodiments have been described above such that, when the user of the portable terminal device 10 displays a map, existence of certain posted information (information posted by another user having a particular relationship with the user) is presented to the user, in which the posted information is associated with the neighborhood of the location designated by the current location designation information.

On the other hand, even if a map is not displayed, the current position of the portable terminal device 10 is periodically detected and transmitted to the purchasing activity promotion device 100, thereby allowing the purchasing activity promotion device 100 to transmit certain posted information as appropriate; and as a result, existence of the certain posted information associated with the neighborhood of the current location of the portable terminal device 10 can be notified by way of vibration and/or sound.

As a result, the user can easily discover the existence of the information posted by another person having a particular relationship with such user, by simply carrying the portable terminal device 10, without the need to display any map.

### Modification Example 6

The embodiments have been described above such that the purchasing activity promotion system 1 includes a plurality of portable terminal devices 10; in addition to the portable terminal devices 10, the purchasing activity promotion system 1 may include a non-portable terminal device (such as, for example, a desktop PC installed in a home).

In the case of such a configuration, for example, a posted information transmission request unit of the terminal device transmits a posted information transmission request, including a user ID, without including location information. The user relationship information acquisition unit of the purchasing activity promotion device 100 refers to the user relationship information database, and detects another user having a particular relationship with the user of the ID thus received. The posted information extraction unit of the purchasing activity promotion device 100 refers to the posted information database, and detects posted information posted by another user, which has been extracted by the user relationship information acquisition unit. The posted information includes data of the content of the posted information (information relating to static/moving image, a comment, or check-in, etc.) and the user ID of the user who posted the posted information is association with the location information corresponding to the posted information. The posted information acquisition unit outputs the data of the content of the posted information extracted by the posted information extraction unit, together with the associated user ID and location information, to the posted information provision data transmission control unit. Then, the posted information provision data transmission control unit of the purchasing activity promotion device 100 transmits the data of the content of the posted information, which is inputted from the posted information acquisition unit, together with the user ID and the location information associated with the posted information, as a list of the posted information data (posted information provision data), which has been posted by another user having a particular relationship with the user who made the posted information transmission request, to the terminal device.

When the terminal device receives the posted information provision data from the purchasing activity promotion device 100, the posted information reception control unit extracts: the data of the content (static/moving image, etc.) included in the posted information provision data; the ID of another user who has posted the content; and the location information corresponding to the posted information.

The posted information display control unit of the terminal device displays a list of the posted information posted by another user having a particular relationship with the user who made the posted information transmission request.

Subsequently, when the user selects the posted information, the location information associated with the posted information is transmitted from the terminal device to the purchasing activity promotion device 100; and the URL transmitting unit of the purchasing activity promotion device 100 transmits a URL of a website associated with the shop corresponding to the location information (for example, a URL of an online store, a URL of an official website operated by the shop brand, etc.) to the terminal device.

As a result, on the non-portable terminal device, the posted information posted by another user having a particular relationship with a user is presented to such user; and when the user selects the posted information, the URL associated with the shop corresponding to the location information of the posted information is transmitted to the terminal device.

Therefore, the user is presented with posted information associated with posted information in which the user is interested within the vicinity of his location; therefore, it is possible to provide greater motivation to promotes the purchasing activity of such user.

### Modification Example 7

The embodiments have been described above such that the posted information is presented to another user having a particular relationship with the user.

On the other hand, posted information posted by the user may be presented to another user having a particular relationship where such information has been explicitly registered as information to be shared.

For example, any user ID is designated from among the users having particular relationships, thereby making it possible to share posted information on an individual user basis; or share posted information within group of users registered as having the a particular relationship (for example, “family”, etc.).

As a result, the sharing of the posted information can be flexibly registered in accordance with the user requirements; and the posted information to be presented can be made more relevant for each user.

The processing sequence described above can be executed by hardware, and can also be executed by software.

In other words, the hardware configurations shown in FIGS. 3 and 6 are merely illustrative examples, and the present invention is not particularly limited thereto. More specifically, the types of functional blocks employed to realize the aforementioned functions are not particularly limited to the examples in FIGS. 3 and 6, as long as the portable terminal device 10 and the purchasing activity promotion device 100 include the functions enabling the aforementioned processing sequence to be executed in its entirety.

A single functional block may be configured by a single piece of hardware, a single installation of software, or any combination thereof.

Where the processing sequence is executed by software, a program configuring the software is installed from a network or a storage medium into a computer or the like.

The computer may be a computer embedded in dedicated hardware. Alternatively, the computer may be a computer capable of executing various functions by installing various programs, e.g., a general-purpose personal computer.

The storage medium containing such a program may not only be configured by the removable medium 31, 131 shown in FIGS. 1 and 5 distributed separately from the device main body to supply the program to a user, but can also be configured pursuant to a storage medium or the like made available to a user in a state which is installed in advance in the main body of the device. The removable medium 31, 131 is composed of, for example, a magnetic disk (including a floppy disk), an optical disk, a magnetic optical disk, or the like. The optical disk is composed of, for example, a CD-ROM (Compact Disk-Read Only Memory), a DVD (Digital Versatile Disk), or the like. The magnetic optical disk is composed of an MD (Mini-Disk) or the like. The storage medium supplied to the user incorporated in advance in the device may include, for example, the ROM 12 shown in FIG. 1, the ROM 112 shown in FIG. 5, a hard disk included in the storage unit 20 shown in FIG. 1 or the storage unit 118 show in FIG. 5, or the like, in which the program is recorded.

In the present specification, the steps describing the program recorded within the storage medium refer not only to processing executed in the order or series set out but also to processing executed in parallel or individually, and not necessarily executed in the same order or series.

In the present specification, terminologies describing a system refer to a whole apparatus configured with a plurality of devices, a plurality of means and the like.

Although some embodiments of the present invention have been described above, the embodiments are merely examples, and do not limit the technical scope of the present invention. Other various embodiments can be employed for the present invention, and various modifications such as omission and replacement are possible without departing from the spirit of the present invention. Such embodiments and modifications are included in the scope of the invention and the summary described in the present specification, and are included in the invention recited in the claims as well as the equivalent scope thereof.

### EXPLANATION OF REFERENCE NUMERALS

1 purchasing activity promotion system
10 portable terminal device
11, 111 CPU
12, 112 ROM
13, 113 RAM
14, 114 bus
15, 115 input/output interface
16 position sensor
17 image capturing unit
18, 116 input unit
19, 117 output unit
20, 118 storage unit
21, 119 communication unit
22, 120 drive
31, 131 removable medium
51 posted information acquisition unit
52 posted information transmission control unit
53 posted information transmission request unit
54 posted information reception control unit
55 map display control unit
91 acquired image storage unit
100 purchasing activity promotion device
151 posted information receiving unit
152 posted information transmission request receiving unit
153 posted information acquisition unit
154 posted information provision data transmission control unit
191 posted information database
192 user relationship information database
193 map information database

1. A purchasing activity promotion device, comprising:
a posted information transmission request receiving unit that receives a posted information transmission request including a user ID for identifying a user, from a terminal device;
based on the user ID, a posted information acquisition unit that acquires posted information about products or services, which have been posted by another user having a particular relationship with the user with such user ID, and posted information associated with the location information; and
a posted information provision data transmission control unit that generates posted information provision data including the posted information acquired by the posted information acquisition unit and the user ID of the user who posted the posted information, and transmits the posted information provision data to the terminal device.

2. The purchasing activity promotion device according to claim 1,
wherein the posted information transmission request receiving unit receives a posted information transmission request, which includes an ID for identifying a user and location information representing a position, from the terminal device;
wherein, based on the user ID and the location information, the posted information acquisition unit acquires the posted information about a product or service, which has been posted by another user having a particular relationship with the user with such user ID, in which the posted information is associated with a registered area from the location represented by the location information.

3. The purchasing activity promotion device according to claim 2,
wherein the posted information transmission request receiving unit receives a map display request, which includes a user ID for identifying a user and location information representing a position to be displayed on a map, as the posted information transmission request; and
wherein the posted information provision data transmission control unit generates linked map data, in which the posted information acquired by the posted information acquisition unit and the user ID of the user who posted the posted information are linked to the map data acquired based on the location information, and transmits the data to the terminal device.

4. The purchasing activity promotion device according to claim 3,
wherein the linked map includes: identification information indicating existence of the posted information displayed on the map; and a list of the posted information corresponding to the identification information; and
wherein, upon selecting the identification information on the map, the posted information corresponding to the selected identification information is identified and displayed in the list of the posted information.

5. The purchasing activity promotion device according to claim 2,
wherein the posted information transmission request includes the user ID of a designated user designated by the user of the terminal device; and
wherein, based on the user ID of the designated user and the location information, the posted information acquisition unit acquires posted information about products or services, which has been posted by another user having a particular relationship with the designated user, in which the posted information is associated with a registered area from the location associated by the location information.

6. The purchasing activity promotion device according to claim 1, further comprising:
a location information receiving unit that receives location information from the terminal device; and
a URL transmitting unit that transmits a URL of an online store associated with a shop to the terminal device, where the location information, which is received by the location information receiving unit, represents a registered area from the location of the shop having a particular relationship with the user of the terminal device.

7. The purchasing activity promotion device according to claim 1, further comprising:
a purchase information receiving unit that receives information indicating that the user purchased a product or service at a shop having a particular relationship with the user of the terminal device;
a page data transmitting unit that transmits payment page data to the terminal device of the user who purchases the product or service;
a page data receiving unit that receives the page data, which has been filled out by the user with required information, from the terminal device; and
a payment execution unit that executes payment processing, based on the page data received by the page data receiving unit.

8. The purchasing activity promotion device according to claim 2,
wherein the posted information transmission request receiving unit receives the posted information transmission request including an ID for identifying a user and location information representing the current location of the terminal device; and
wherein the posted information provision data transmission control unit transmits the posted information acquired by the posted information acquisition unit, and the ID of the user who posted the posted information, to the terminal device.

9. The purchasing activity promotion device according to claim 1, further comprising:
a location information receiving unit that receives location information from the terminal device; and
a URL transmitting unit that transmits a URL of a website associated with a shop and marketing information to the terminal device, where the location information, which is received by the location information receiving unit, represents a registered area associated with the location of the shop having a particular relationship with the user of the terminal device.

10. The purchasing activity promotion device according to claim 1, further comprising:
a URL transmitting unit that transmits a URL associated with a shop corresponding to location information of the posted information, upon receiving the location information corresponding to the selected information posted from the terminal device.

11. A program allowing a computer to implement:
a posted information transmission request receiving function that receives a posted information transmission request including an ID for identifying a user, from a terminal device;
based on the user ID, a posted information acquisition function that acquires posted information about products or services, which have been posted by another user having a particular relationship with the user of such user ID, the posted information being associated with location information; and
a posted information provision data transmission control function that generates posted information provision data including the posted information acquired by the posted information acquisition function and the user ID of the user who posted the posted information, and transmits the posted information provision data to the terminal device.
